(19) United States
(12) Patent Application Publication
(10) Pub. No.: US 2025/0276560 A1
(43) Pub. Date: Sep. 4, 2025

(54) CABIN HEAT DISCHARGE SYSTEM

(71) Applicant: CHEM-DRY, INC., Nashville, TN (US)

(72) Inventor: Wayne Boone, Smithfield, UT (US)

(21) Appl. No.: 19/067,791

(22) Filed: Feb. 28, 2025

Related U.S. Application Data
(60) Provisional application No. 63/559,462, filed on Feb. 29, 2024.

(51) Int. Cl. B60H 1/20; B60H 1/16

(52) U.S. Cl. CPC B60H 1/20; B60H 1/16

(57) ABSTRACT

A cabin heat discharge system is provided that includes an interconnected series of ductwork channel sections that at least partially surround an engine located within the cabin space of a mobile unit. The series of ductwork channel sections partially surround the engine fan to capture air exhaust blown from the engine. The ductwork channel sections downstream of the engine fan partially surround additional components of the engine and the captured air traveling through the channel sections absorbs radiant heat of the engine components. The series of ductwork channel sections downstream of the engine fan includes an outlet section that discharges the heated captured air outside of the mobile unit.

### CROSS-REFERENCE TO RELATED APPLICATIONS

The application claims priority to U.S. Provisional Patent Application Ser. No. 63/559,462, filed on Feb. 29, 2024, to Wayne Boone, entitled “Cabin Heat Discharge System,” currently pending, the entire disclosure of which is incorporated herein by reference.

### BACKGROUND OF THE INVENTION

Industrial, engine-powered equipment is often deployed in mobile units so that the equipment can be transported and used at different locations. One such example is industrial and commercial cleaning equipment, such as a truck mount carpet cleaning machine and the like. Another example is large-scale power-washing equipment. This type of equipment is typically large-scale equipment powered by an engine. Both the equipment and the engine are situated in a vehicle, trailer or other type of mobile unit. For example, equipment vans or trucks where an equipment cabin is configured in the rear of the vehicle. During operation of the equipment, the engine generates a significant amount of radiant energy or heat. Because the engine is situated in the confined cabin space of the vehicle or mobile unit, the radiant energy and heat generated significantly raises the temperature in the cabin space. This can not only be hazardous and cause discomfort to an operator within the cabin space and adjacent areas of the mobile unit, but the temperature levels can adversely impact the parts and components of the equipment powered by the engine. For example, electrical wiring and operating hoses can become brittle, computer and electronic components can overheat. As a result, various components of the equipment can malfunction, fail and/or have a reduced lifespan. Accordingly, a need exists for a system for reducing the heat and temperature levels within the cabin space for mobile equipment powered by an engine.

### BRIEF SUMMARY OF THE INVENTION

The present invention is directed to a cabin heat discharge system for use with an equipment engine located within the cabin space of a mobile unit, such as an equipment van, trailer or other mobile structure. The cabin heat discharge system may be positioned adjacent to and along the engine to capture air from the engine fan and move the air along the components of the engine to absorb and capture radiant energy or heat emitted from the engine components during operation. The cabin heat discharge system may further discharge the captured air outside the mobile unit after it has absorbed the radiant heat from the engine and increased the temperature of the captured air. The cabin heat discharge system operates to remove at least a portion of the emitted radiant heat generated by the engine within the cabin space and thereby limit the temperature increase within the cabin space caused by operation of the engine.

The cabin heat discharge system may be used for an equipment unit having an engine located within a mobile unit. The system may comprise a ductwork network formed around at least a portion of the engine. The ductwork network may comprise a plurality of ductwork sections fluidly connected together, where the sections capture air from the engine fan and discharge the captured air outside the mobile unit. During operation of the engine, radiant heat generated by the engine is transferred to the captured airflow traveling through the ductwork network.

The cabin heat discharge system may further include at least one heat shield panel located adjacent to the engine.

The ductwork network of cabin heat discharge system may include a first section positioned adjacent to the engine fan and configured to capture airflow from the engine fan. The first section may include enclosed back and side walls and a partially open front wall or surface facing the engine fan.

The ductwork network may further include a second section positioned adjacent to an exhaust manifold of the engine and at least partially surrounding the exhaust manifold. The second section may be downstream of the first section and fluidly connected thereto to receive the captured air from the first section. The second section may include enclosed back, top and bottom walls and form a C-shaped channel that at least partially surrounds the exhaust manifold. The second section enables radiant heat transfer from the exhaust manifold to the capture air traveling through the second section.

The ductwork network may further include a third section positioned around a catalytic converter of the engine. The third section may be downstream of the second section and fluidly connected thereto. The third section at least partially encloses the catalytic converter and enables radiant heat transfer from the catalytic converter to the captured airflow traveling through the third section.

The ductwork network of the cabin heat discharge system may further include a fourth section positioned downstream of the third section and fluidly connected thereto. The fourth section may include an opening for receiving at least one of engine exhaust air and blower air and combine the engine exhaust and/or blower air with the captured air from the third section. The ductwork network of the cabin heat discharge system may further include a fifth section positioned downstream of the fourth section and fluidly connected thereto. The fifth section may be configured as enclosed conduit or pipe that extents outside the mobile unit and includes an outlet or opening exterior to the mobile unit for discharging the captured air traveling through the ductwork network.

In one aspect the cabin heat discharge system may be configured for use with a truck mount unit having an engine and provided within a cabin space of a mobile unit.

Further advantages, features and details of the invention are elucidated on the basis of preferred embodiments thereof, wherein reference is made to the accompanying drawings.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a perspective view of a cabin heat discharge system used with engine-powered equipment in a mobile unit in accordance with one embodiment of the present invention;

FIG. 2 is a perspective view of the cabin heat discharge system of FIG. 1 illustrating the system located adjacent an engine for operating equipment within a cabin space of the mobile unit;

FIG. 3 is a perspective view of the cabin heat discharge system of FIG. 1 illustrating the system located adjacent an engine;

FIG. 4 is a perspective view of the cabin heat discharge system of FIG. 1 illustrating the system positioned adjacent an engine and operating equipment;

FIG. 5 is a schematic perspective view of the cabin heat discharge system of FIG. 1 illustrating the arrangement of the system adjacent operating equipment and an engine;

FIG. 6 is a schematic perspective view of the cabin heat discharge system of FIG. 1 illustrating the arrangement of the system adjacent operating equipment and an engine;

FIG. 7 is a schematic top perspective view of the cabin heat discharge system of FIG. 1 illustrating the arrangement of the system adjacent operating equipment and an engine;

FIG. 8 is a front perspective view of the cabin heat discharge system of FIG. 1 illustrating the arrangement of the system adjacent operating equipment and an engine; and

FIG. 9 is a schematic perspective view of the cabin heat discharge system of FIG. 8 illustrating an airflow path of captured air traveling through the system.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. It will be appreciated that some or all of the various features and structures described and shown with respect to each of the specific embodiments referenced herein may be combined to form additional or alternative embodiments having such combinations and that such combinations are within the scope of the present invention.

The present invention is directed to a heat discharge system 10 configured for use with equipment and/or machinery powered by an engine and located within a confined cabin space, or equipment space, of a mobile unit. In particular, the heat discharge system 10 is configured for capturing radiant heat generated by an engine and discharging the captured heat outside the confined cabin space containing the engine. The system 10 may be used in several different applications, and in particular, applications where an engine for powering equipment is located in a small defined cabin space, or equipment space, of a vehicle or trailer. According to one embodiment as shown in the figures, the heat discharge system 10 is configured as a cabin heat discharge system for use with truck mount cleaning equipment contained in a mobile unit, such as an equipment van, truck, trailer, or other mobile structure having a defined cabin space or equipment space 102. The cabin heat discharge system 10 may also be suitably used with any other type of industrial and/or commercial equipment that utilizes a dedicated engine for powering the equipment and is not necessarily limited to use in truck mount units or similar types of cleaning equipment. For example, power washing equipment is often powered by an engine where the equipment and engine are situated in an equipment van or trailer.

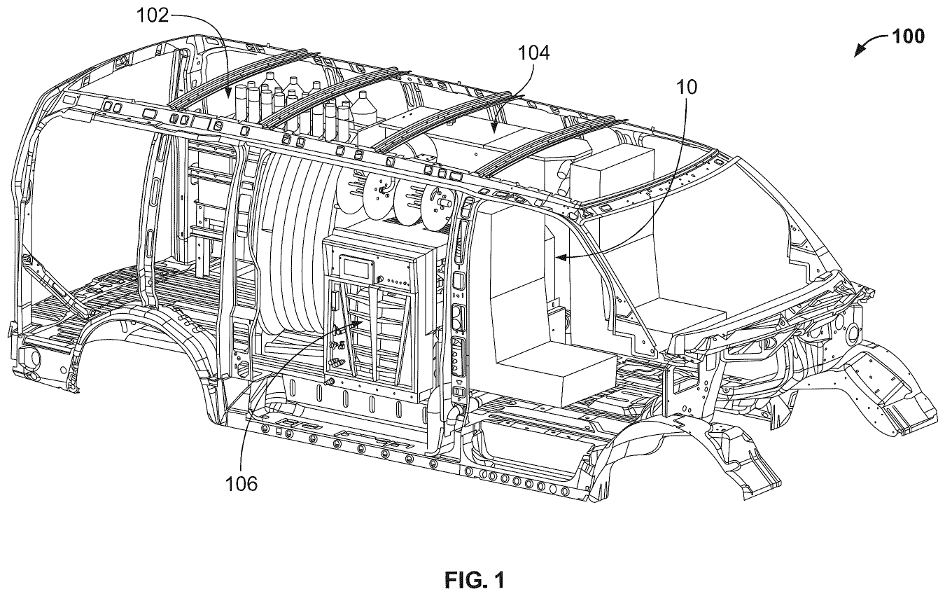

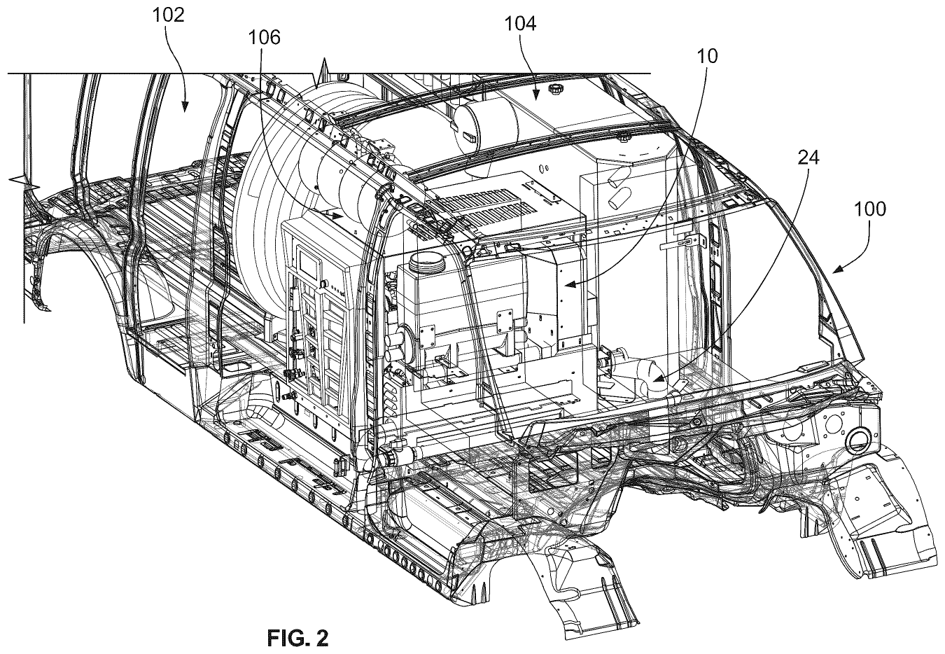

FIGS. 1 and 2 show a mobile unit 100 (configured as an equipment vehicle) that has a cabin space 102 for housing operating equipment 104 (such as a truck mount unit) and an engine 106 to operate the equipment 104. A truck mount is a carpet/upholstery/floor cleaning equipment system that uses an engine 106 to generate high-pressure water and heat used to clean carpets, upholstery and other surface. It is also recognized that the system 100 of the present invention may be configured for any other type of operating equipment 104 (such as power washer machines or other equipment) that uses an engine for operation and is contained within an enclosed cabin space of a mobile unit 100.

The engine 106 may be configured as any suitable type of engine, including without limitation, a water-cooled or air-cooled engine, diesel engine, gasoline engine, or other engine design. The engine 106 shown in the figures is configured as a water-cooled engine; however, system 10 can easily be configured for any other type of engine configuration.

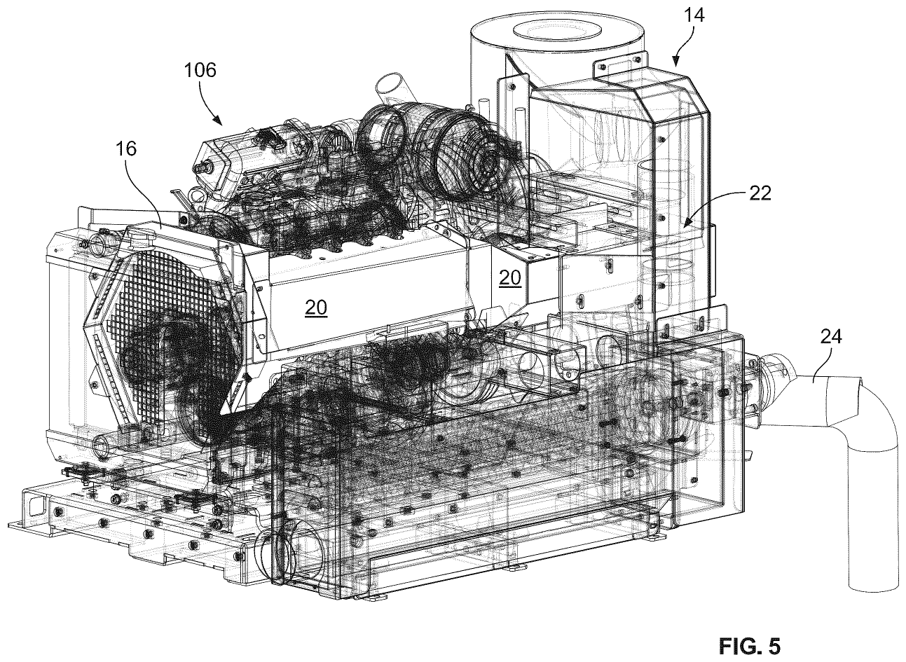

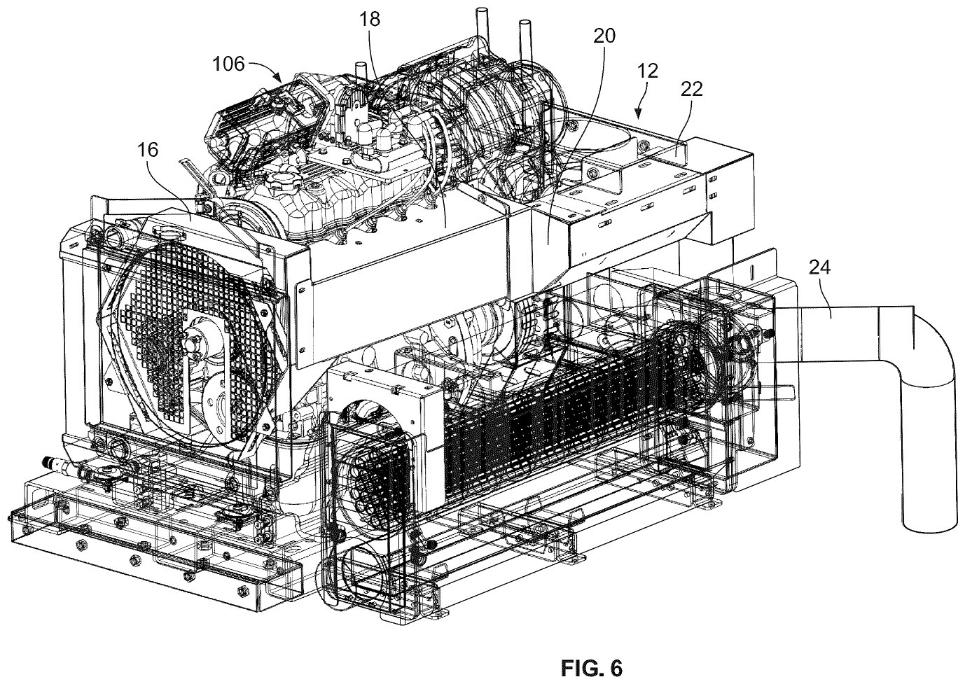

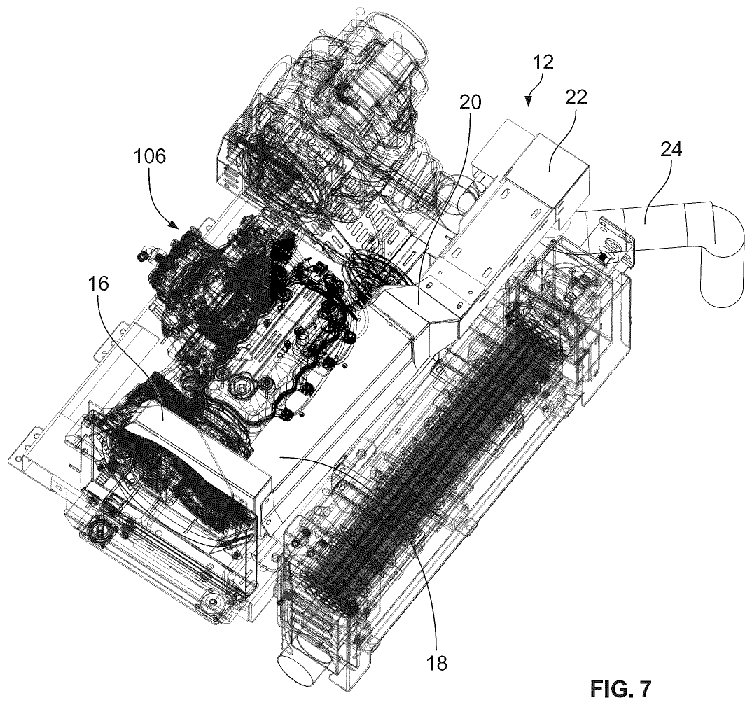

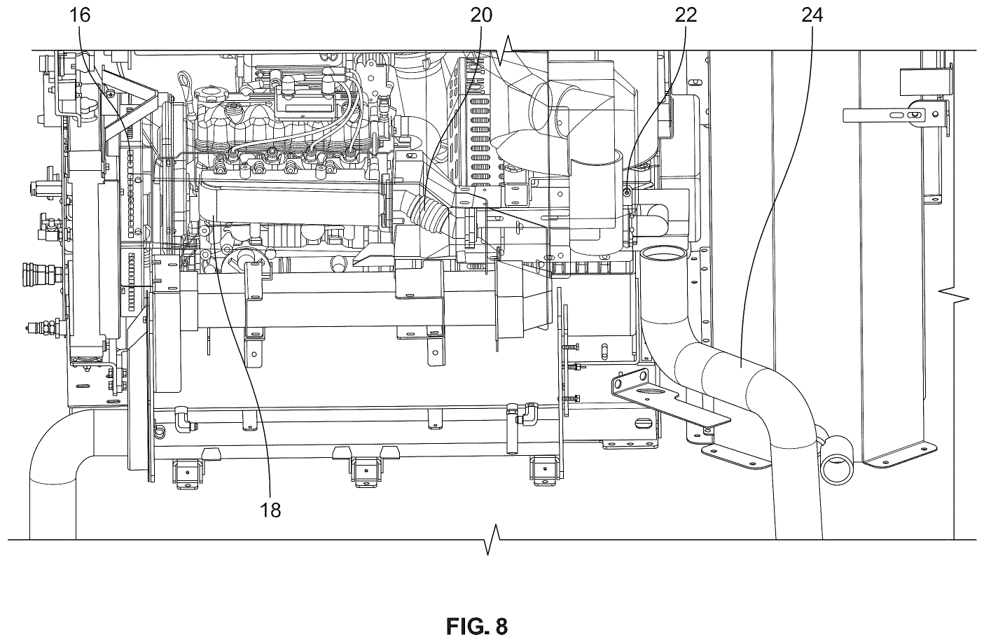

As illustrated in FIGS. 1-9, the cabin heat discharge system 10 is configured to surround at least a portion of the engine 106 and operates to collect and remove radiant heat produced by the engine 106 during operation of the equipment 104. During operation of the equipment 104, the engine 106 generates a significant amount of radiant energy or heat by means of increased temperature and conduction and heat transfer by the engine parts. Because the engine 106 is located in a small, confined space (i.e., cabin space 102) of a mobile unit 100, the generated heat (or radiant energy) from the engine is radiated out into the cabin space 102. This significantly increases the temperature of the cabin space 102, which can damage parts and components of the equipment and make the cabin space 102 uncomfortable for an operator or person in the cabin space 102. System 10 of the present invention is configured to capture and remove at least a portion of the radiant energy or heat generated by the engine 106 that would otherwise remain in the cabin space 102 and increase the temperature therein. System 10 may also be configured to protect and shield operators within the cabin space 102 from the engine 106 and the radiant energy produced therefrom.

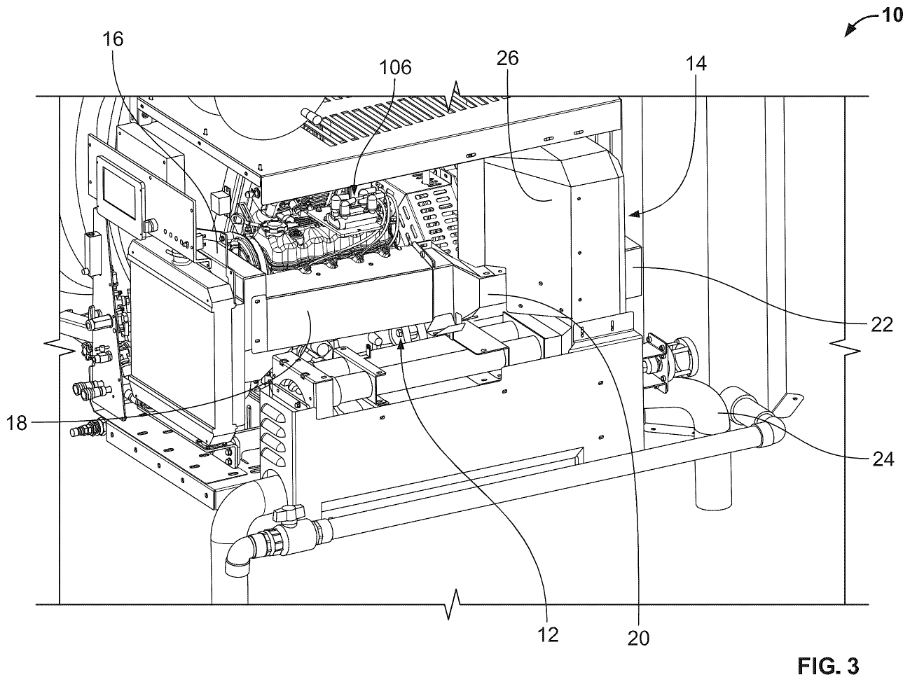

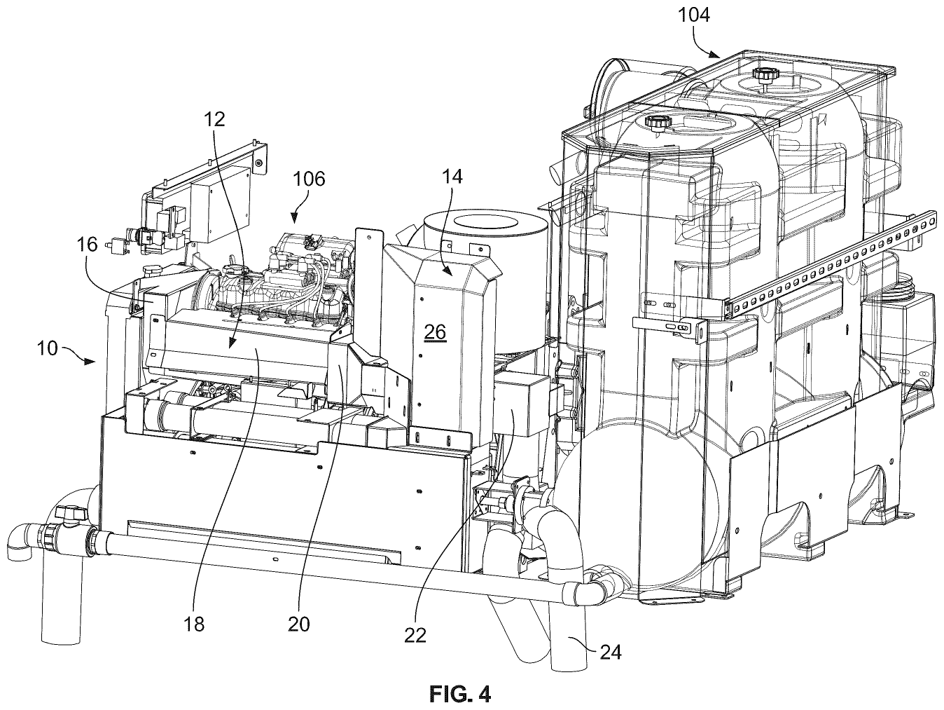

As shown in FIGS. 3 and 4, system 10 can include an air transfer ductwork network or channel component 12 and a heat shield component 14. As described in greater detail below, the air transfer channel component or ductwork network 12 operates as a continuous series of ductwork or channel sections that surround one or more portions of the engine 106. The ductwork network 12 can capture air blown from the engine 106 (via the engine fan), transfer the captured air along the exhaust portions of the engine, and then discharge the air from the mobile unit 100. As a result, the system 10 can function to capture radiant energy and heat generated by the engine 106 by transferring the radiant energy and heat to a controlled airstream that is then discharged from the cabin space 102.

As shown in FIGS. 3-9, system 10 can be configured with a ductwork channel network 12 that surrounds portions of the engine 106 (particularly the exhaust portions of the engine). The ductwork network 12 can include a first air capture section 16 that is positioned adjacent the engine fan. The first section 16 can be configured as a shroud that surrounds a portion of the engine fan so that air blown from the fan enters first section 16 and system 10. As best shown in FIG. 3, the first section 16 can include an enclosed back wall and side walls and a partially open front wall facing the fan component of the engine 106 to enable the first section 16 to capture and retain the air blown from the engine fan during operation of the engine 106.

As further shown in FIGS. 3-9, system 10 and ductwork network 12 further includes a second exhaust manifold section 18 downstream of the first air capture section 16, as shown in FIG. 4. The second section 18 is fluidly connected to the first section 16 so that the captured air from the engine fan can transfer to second section 18. Second section 18 surrounds and encapsulates the engine exhaust manifold and can extend along all or at least portion of the length of the manifold, preferably all or a majority of the length of the manifold. The second section 18 can also surround associated exhaust piping of the engine. According to one embodiment, as illustrated by the several figures, the second section 18 can include an enclosed back wall and top and bottom walls that surround the exhaust manifold and associated exhaust piping of the engine 106. The second section 18 may further include an open or partially open front wall or surface facing the exhaust manifold portion of the engine 106 (between the top and bottom walls of the second section 18). The resulting structure can be configured as a general C-shaped channel with at least one partially open face adjacent the exhaust manifold.

As the captured air travels through the second section 18, radiant energy or heat from the engine is transferred from the manifold to the captured air (via convective heat transfer at the open front wall portion of the second section 18). The air from the engine 106 at this manifold section can be upwards of 1,000 degrees Fahrenheit. The air absorbs the radiant heat and as a result retains the heat within system 10 rather than the cabin space 102.

As shown in FIGS. 3-9, system 10 and ductwork network 12 can further include a third section 20 that surrounds and encapsulates the catalytic converter for the engine 106. Third section 20 can be arranged downstream of the second section 18 and can be in fluid connection therewith so the captured air can continuously transition through system 10. As illustrated in the several figures, the third section 20, according to one embodiment, may include front and back walls and top and/or bottom walls that surround and enclose the catalytic converter within the interior space of the third section 20. As the captured air passes over the catalytic converter, the air absorbs heat from the catalytic converter via heat transfer. The captured air in this third section 20 can be approximately 800-900 degrees Fahrenheit.

As further shown in FIGS. 3-9, system 10 and ductwork network 12 can further include a fourth section 22 that is downstream of the third section 20. The fourth section 22 can be configured as an enclosed chamber that receives both the blower exhaust from the blower (or vacuum pump) of the operating equipment 106 and the engine exhaust traveling from the third section 20. According to one embodiment as illustrated in the figures, the fourth section 22 can include front, back, top and bottom walls that define the enclosed chamber structure and interior space contained therein. The fourth section 22 may further include an opening for receiving engine exhaust air and/or blower exhaust air from the blower and an opening for receiving the captured air from the third section 20. The combined airstreams (the captured air, engine exhaust and/or blower exhaust air streams) can be combined within fourth section 22 for discharge outside the mobile unit 100.

As further shown in FIGS. 3-9, system 10 and ductwork network 12 can further include a fifth discharge section 24 that is fluidly connected to and downstream of the fourth section 22. The fifth section 24 can be configured as conduit or pipe that travels from the fourth section 22 to the floor or lower surface of the mobile unit 100 (which can be the floor of the vehicle as shown in the figures). As illustrated in the several figures, according to one embodiment, the fifth section 24 can be configured as piping or other fully enclosed conduit that defines an enclosed interior space housing the traveling captured air traveling from the fourth section 22. The combined engine exhaust/blower exhaust air and captured air can travel through the fifth section 24 and then exit at an opening located outside or exterior of the cabin space 102 and mobile unit 100. The combined air in this fifth section 24 can be approximately 400 degrees Fahrenheit.

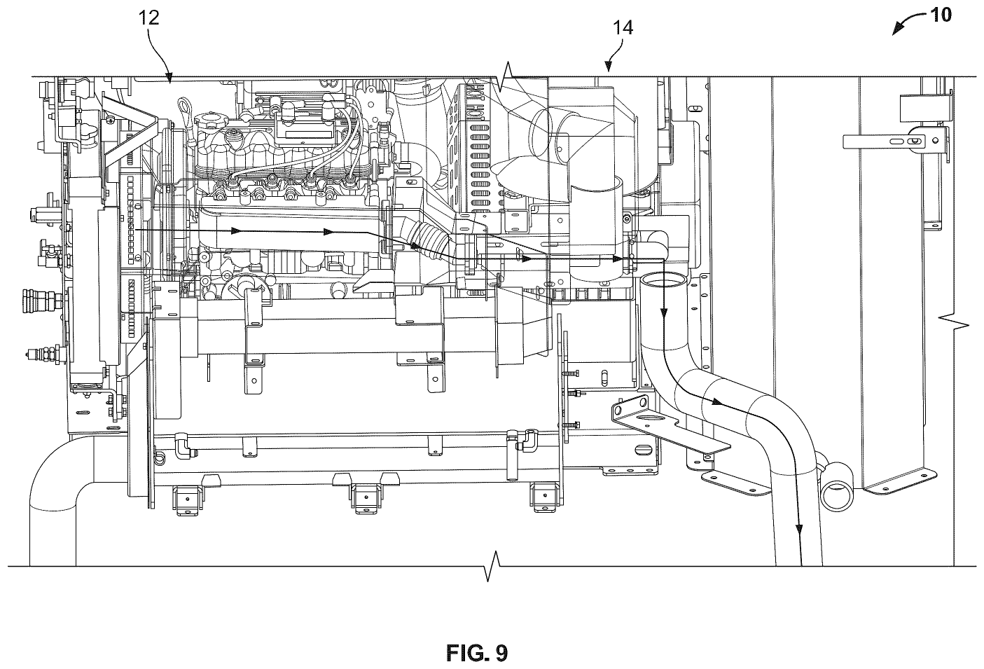

As shown in the figures, sections 16-24 can be interconnected together to form a continuous channel or ductwork network that collects air from the engine and funnels or forces that collected air along the channel to capture radiant energy or heat being emitted by the engine 106 and then discharge the captured outside the cabin space 102. FIG. 9 provides a schematic representation of the airflow path of the captured air through system 10 and ductwork network 12. The channel sections 16-24 of the ductwork network 12 surround and enclose portions of the engine 106 (as described above) so that at least a significant portion of the heat or energy radiating from the engine 106 is transferred to the air retained in the system 10 and not emitted into the cabin space 102. Each channel section 16-24 may be configured as one or more panel components connected together (by welding, bolts, or other suitable connection methods). The system 10 further captures the air blown from the engine and/or blower so that the blown air is not emitted into the cabin space 102.

As further shown in the figures, the cabin heat discharge system 10 can also include a heat shield component 14 that is positioned around portions of the engine 106. The heat shield component 14 can be configured as a series of panel structures 26 that positioned around the engine components and shield the engine surfaces from contact by an operator or user within the cabin space 102.

The channel sections 16-24 and heat shield panels 26 can be constructed using any suitable material or materials. According to the embodiment shown in the figures, both the channel sections 16-24 and heat shield panels 26 are constructed from stainless steel; however, this is merely one example of a suitable material and a number of different materials may be suitably used.

From the foregoing, it will be seen that this invention is one well adapted to attain all the ends and objects hereinabove set forth together with other advantages which are obvious, and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A cabin heat discharge system for an equipment unit having an engine located within a cabin space of a mobile unit, the system comprising:
a ductwork network formed around at least a portion of the engine, wherein the ductwork network comprises a plurality of ductwork sections fluidly interconnected to one another, wherein the plurality of ductwork sections capture airflow from an engine fan of the engine and discharge the captured airflow outside the mobile unit;
wherein radiant heat generated by the engine during operation of the engine is transferred to the captured airflow as the captured airflow travels through the ductwork network.

2. The system of claim 1, further comprising at least one heat shield panel, wherein the at least one heat shield panel is located adjacent to at least a portion of the engine.

3. The system of claim 1, wherein the plurality of ductwork sections of the ductwork network comprises:
a first section positioned adjacent to at least a portion of the engine fan and configured to capture airflow from the engine fan;
a second section at least partially surrounding an exhaust manifold of the engine, wherein the second section is located downstream of the first section and configured to receive the captured airflow from the first section; and
a third section at least partially surrounding a catalytic converter of the engine, wherein the third section is located downstream of the second section and configured to receive the captured airflow from the second section.

4. The system of claim 3, wherein the first section comprises an enclosed back wall and at least partially open front surface facing the engine fan for receiving the captured airflow from the engine fan.

5. The system of claim 4, wherein the second section comprises a C-shaped channel facing the exhaust manifold of the engine.

6. The system of claim 5, wherein the captured airflow within the second section absorbs radiant heat from the exhaust manifold of the engine.

7. The system of claim 3, wherein the plurality of ductwork sections of the ductwork network further comprises:
a fourth section comprising a chamber located downstream of the third section and configured to receive the captured airflow from the third section; and
a fifth section comprising fully enclosed conduit located downstream of the fourth section, wherein the fifth section extends outside the mobile unit.

8. The system of claim 7, wherein the fourth section further comprises an opening configured to receive at least one of engine exhaust air from the engine and blower exhaust air from a blower unit associated with the engine.

9. The system of claim 7, wherein the fifth section further comprises an opening located outside of the mobile unit for discharging the captured airflow within the ductwork network.

10. The system of claim 1, wherein the system is configured to reduce a temperature increase within the cabin space of the mobile unit during operation of the engine.

11. A cabin heat discharge system for use with a truck mount unit including an engine having an engine fan, an exhaust manifold, a catalytic converter and a blower, the system comprising:
a ductwork network comprising:
a first section located adjacent to the engine fan for receiving blown fan airflow within an interior volume of the first section as captured airflow;
a second section located downstream of the first section and adjacent to the exhaust manifold, wherein the second section at least partially surrounds the exhaust manifold, and wherein the second section receives the captured airflow from the first section;
a third section located downstream of the second section and adjacent the catalytic converter, wherein the third section at least partially surrounds the catalytic converter, and wherein the third section receives the captured airflow from the second section;
a fourth section located downstream of the third section, wherein the fourth section includes and inlet for receiving at least one of engine exhaust air and blower air from the blower, and wherein the fourth section receives the captured airflow from the third section; and
a fifth section located downstream of the fourth section and extending outside of the mobile unit, wherein the fifth section receives the captured airflow from the fourth section;
wherein radiant heat generated by the engine during operation of the truck mount unit is transferred to the captured airflow as the captured airflow travels through the ductwork network.

12. The system of claim 11, further comprising at least one heat shield panel, wherein the at least one heat shield panel is located adjacent to at least a portion of the engine.

13. The system of claim 11, wherein the fifth section further comprises an outlet located exterior of the mobile unit for discharging the captured airflow within the ductwork network.

14. The system of claim 11, wherein the first section, second section, third section, fourth section and fifth section are fluidly connected to one another to enable the captured airflow to travel along the entirety of the ductwork network.

15. The system of claim 11, wherein the fourth section is configured to combine the blower air and the captured airflow to form a combined captured airflow.

16. The system of claim 15, wherein the fifth section is configured to discharge the combined captured airflow outside the mobile unit through an outlet of the fifth section located exterior to the mobile unit.

17. The system of claim 11, wherein the second section enables radiant heat transfer from the exhaust manifold to the captured airflow within the second section.

18. The system of claim 17, wherein the third section enables radiant heat transfer from the catalytic converter to the captured airflow within the third section.

19. A truck mount system for use in a mobile unit having a cabin space, the truck mount system comprising:
an engine located in the cabin space and comprising an engine fan for blowing engine air, an exhaust manifold, and a catalytic converter; and
a cabin heat discharge unit located adjacent the engine and comprising ductwork network formed around at least a portion of the engine, wherein the ductwork network comprises a plurality of ductwork sections fluidly interconnected to one another, wherein the plurality of ductwork sections capture airflow from the engine fan and discharge the captured airflow outside the mobile unit;
wherein radiant heat generated by the engine during operation of the equipment is transferred to the captured airflow as the captured airflow travels through the ductwork network.

20. The system of claim 19, further comprising at least one heat shield panel, wherein the at least one heat shield panel is located adjacent to at least a portion of the engine.
